(19) United States
(12) Patent Application Publication
(10) Pub. No.: US 2022/0101870 A1
(43) Pub. Date: Mar. 31, 2022

(54) NOISE FILTERING AND VOICE ISOLATION DEVICE AND METHOD

(71) Applicant: Zinfanite Technologies, Inc., Torrance, CA (US)

(72) Inventor: Jana Mahen Fernando, Torrance, CA (US)

(21) Appl. No.: 17/477,841

(22) Filed: Sep. 17, 2021

Related U.S. Application Data
(60) Provisional application No. 63/084,604, filed on Sep. 29, 2020.

(51) Int. Cl. G10L 21/0224; H04R 1/40; H04R 3/00; G10L 21/028; G10L 21/057; G10L 25/51

(52) U.S. Cl. CPC G10L 21/0224; H04R 1/406; H04R 3/005; G10L 2021/02165; G10L 21/057; G10L 25/51; G10L 21/028

(57) ABSTRACT

A method of isolating voice signal from a user, the method including capturing a first audio signal by a first microphone; capturing a second audio signal by a second microphone, the second microphone located at a distance from the first microphone; transmitting the first audio signal from the first microphone and the second audio signal from the second microphone to a processor; comparing, by the processor, the first audio signal and the second audio signal with a time delay corresponding to the distance between the first microphone and the second microphone; and finding a commonality between the first audio signal and the second audio signal if the first audio signal and the second audio signal are substantially different.

### CROSS REFERENCE TO RELATED PATENT APPLICATION

This application claims the priority of U.S. Provisional Application No. 63/084,604, filed Sep. 29, 2020, the entirety of which is hereby incorporated by reference.

### FIELD

This relates generally to noise filtering and voice isolation, and more particularly, to an electronic device with two microphones for achieving superior noise filtering and voice isolation.

### BACKGROUND

Many existing devices use a single microphone to capture audio. It can be difficult to differentiate between the speaker's voice versus someone in close proximity to the speaker who happens to be talking at the same time. The loudness of different noises captured by the single speaker may not accurately correspond to the proximity of the speaker, for example, when someone or something could be making a quite large sound from a distance.

There are also existing filtering techniques that can eliminate noise that is somewhat constant such as a fan whirring in the background. However, these filtering techniques may be flawed and could lose audio that is intended to be picked up by the microphone.

### SUMMARY

This disclosure relates to an electronic device having two microphones for capturing noises and a processor for performing noise filtering and voice isolation from the captured noises.

### BRIEF DESCRIPTION OF THE DRAWINGS

FIG. 1 illustrates a user wearing two microphones for capturing noise, according to an embodiment of the disclosure.

FIG. 2 is a block diagram illustrating the exemplary components of an electronic device, according to an embodiment of the disclosure.

FIG. 3 is a flow chart illustrating the exemplary steps in a method of filtering noise, according to an embodiment of the disclosure.

### DETAILED DESCRIPTION OF THE PREFERRED EMBODIMENTS

In the following description of preferred embodiments, reference is made to the accompanying drawings which form a part hereof, and in which it is shown by way of illustration specific embodiments, which can be practiced. It is to be understood that other embodiments can be used and structural changes can be made without departing from the scope of the embodiments of this disclosure.

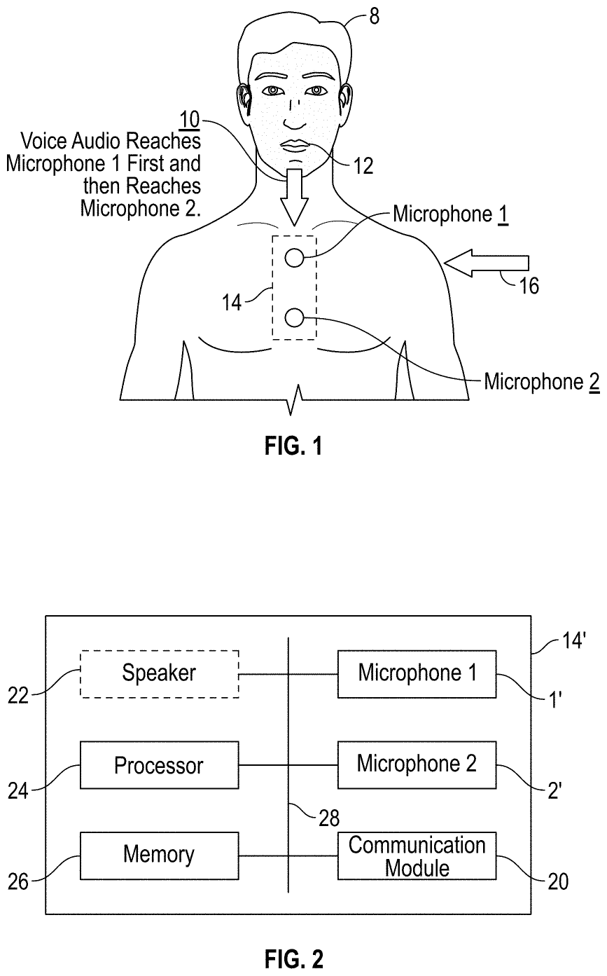

This disclosure generally relates to noise filtering and/or voice isolation using two microphones positioned at different distances from an audio source. FIG. 1 illustrates an example of a user 8 having an electronic device 14 positioned in front his chest. The electronic device can be a wearable device such as one that can be worn like a necklace. It can be in any shape such as a pendant. It can be a mobile device such as a cell phone hanging around the neck of the user 8. The electronic device 14 can include two microphones 1, 2. The electronic device 14 can be designed such that microphones 1, 2 are at difference distances from the user's mouth 12 when the device 14 is carried on (or attached to) the user 8 as designed. As illustrated in FIG. 1, microphone 1 is positioned closer to the user's mouth 12 than microphone 2.

When the user speaks, the voice audio signal 10 reaches microphone 1, which is closer to the user's mouth 12, moments before it reaches microphone 2, which is farther away from the user's mouth 12. A microprocessor in the electronic device that is monitoring the audio signals 10 then compares the two signals captured by microphones 1, 2 with a time delay in the data that is proportional to the distance between the two microphones 1, 2. When no significant ambient noise is present, the two audio signals received by microphones 1, 2 will be more or less the same, when the time delay is taken into consideration. When ambient noise 16 from a distant source is present and also captured, there will be a difference between the two signals. The difference represents the ambient noise 16. This ambient noise 16 can then be subtracted out of the audio signals thus delivering superior isolation of the voice signal 10 from the user 8. This allows for improved voice recording and/or voice transmission quality when the user 8 uses the electronic device 14 to send a voice message or make a call in a noisy environment.

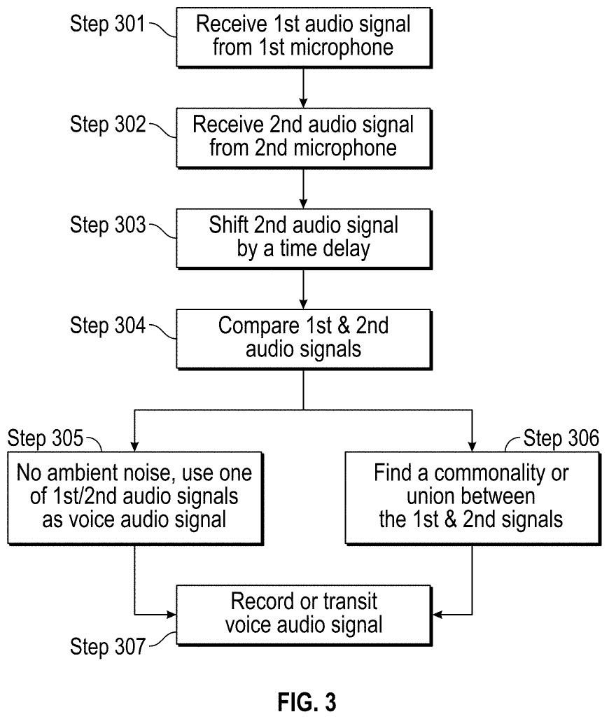

FIG. 2 illustrates the exemplary components of the electronic device 14′ such as the device 14 shown in FIG. 1. The electronic device 14′ can include a processor 24, memory (or other type of storage component) 26, microphones 1′, 2′, speaker 22, and a communication module 20, all connected by a bus 28. The microphones 1′, 2′ can capture audio signals from the surroundings and transmit the signals to the processor 24. The processor 24 can perform the noise filtering and voice isolation methods described with reference to FIGS. 1 and 3. The memory (or storage) 26 can store data and instructions for performing the methods described with reference to FIGS. 1 and 3. The storage can be any non-transitory computer readable storage medium, such as a solid-state drive or a hard disk drive, among other possibilities. The communication module 20 and the speaker 22 can be optional. The communication module 20 can communicate audio signals with another device. The speaker 22 can output audio signals received from the communication module 20.

FIG. 3 is a flow chart illustrating the exemplary steps in a method for noise filtering/voice isolation, according to an embodiment of the disclosure. The method of FIG. 3 can be carried out by the processor 24 of the electronic device of FIG. 2 using instructions stored in memory 26 of the same device.

First, the processor receives a first audio signal from a first microphone (step 301). The processor can receive a second audio signal from a second microphone (step 302). The second audio signal is then shifted by a time delay (step 303). The time delay can be set based on the relative position of the two microphones on the device. The processor compares the first and second audio signals shifted by the time delay (step 304). The time delay can be predetermined based on the physical distance between the two microphones. If the first and second audio signals are substantially the same, the processor determines that there is no significant ambient noise and the audio signal from one of the microphones is used as the voice audio signal (step 305). Alternatively, if the first and second audio signals are different, a commonality or union between the two signals can be found (step 306). For example, there may be noise on the first signal at a certain frequency and noise on the second signal at a different frequency but the audio waveform which is present in both signals at the same frequencies (i.e., the commonality or union between the two signals) can be identified to represent the voice of the user. Optionally, after the voice audio signal is isolated, the voice audio signal can be recorded or transmitted to another device (step 307). The voice audio signal can also be used for other purposes such as activating certain functions of the device. In some embodiments, the processor may also adjust the volume output from the isolated voice signal by boosting or reducing the signal.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. An electronic device comprising:
a first microphone configured to capture a first audio signal;
a second microphone configured to capture a second audio signal, the second microphone located at a distance from the first microphone; and
a processor in communication with the first microphone and the second microphone, the processor configured to receive the first audio signal from the first microphone and the second audio signal from the second microphone;
wherein the processor is further configured to:
compare the first audio signal and the second audio signal with a time delay corresponding to the distance between the first microphone and the second microphone; and
generate an isolated audio signal by finding a commonality between the first audio signal and the second audio signal if the first audio signal and the second audio signal are substantially different.

2. The electronic device of claim 1, wherein the processor is further configured to store or transmit the isolated audio signal to another device.

3. The electronic device of claim 1, wherein the processor is further configured to activate another function of the electronic device in response to the isolated audio signal.

4. The electronic device of claim 1, wherein the processor is further configured to determine that there is no significant ambient noise in response to detecting no significant difference between the first audio signal and the second audio signal.

5. The electronic device of claim 1, wherein the processor is further configured to determine a commonality or union between the first audio signal and the second audio signal if the first and second audio signals are substantially different.

6. The electronic device of claim 1, wherein comparing the first audio signal and the second audio signal with a time delay corresponding to the distance between the first microphone and the second microphone further comprises shifting the second audio signal by a time delay.

7. A method of isolating voice signal from a user, the method comprising:
capturing a first audio signal by a first microphone;
capturing a second audio signal by a second microphone, the second microphone located at a distance from the first microphone;
transmitting the first audio signal from the first microphone and the second audio signal from the second microphone to a processor;
comparing, by the processor, the first audio signal and the second audio signal with a time delay corresponding to the distance between the first microphone and the second microphone; and
finding a commonality between the first audio signal and the second audio signal if the first audio signal and the second audio signal are substantially different.

8. The method of claim 7, further comprising generating an isolated audio signal from the commonality between the first audio signal and the second audio signal.

9. The method of claim 8, further comprising storing the isolated audio signal.

10. The method of claim 8, further comprising transmitting the isolated audio signal to another device.

11. The method of claim 8, further comprising activating another function of the electronic device in response to the isolated audio signal.

12. The method of claim 7, further comprising determining that there is no significant ambient noise in response to detecting no significant difference between the first audio signal and the second audio signal.

13. The method of claim 7, wherein comparing, by the processor, the first audio signal and the second audio signal with the time delay corresponding to the distance between the first microphone and the second microphone further comprises shifting the second audio signal by a time delay.
